(19) United States
(12) Patent Application Publication
(10) Pub. No.: US 2020/0367005 A1
(43) Pub. Date: Nov. 19, 2020

(54) ACOUSTIC PROCESSING APPARATUS, ACOUSTIC PROCESSING METHOD, AND PROGRAM

(71) Applicant: Sony Corporation, Tokyo (JP)

(72) Inventors: Tetsunori ITABASHI, Kanagawa (KR); Shigetoshi HAYASHI, Tokyo (JP); Toru NAKAGAWA, Chiba (JP); Ryutaro WATANABE, Tokyo (JP)

(73) Assignee: Sony Corporation, Tokyo (JP)

(21) Appl. No.: 16/959,750

(22) PCT Filed: Oct. 25, 2018
(86) PCT No.: PCT/JP2018/039658

§ 371 Date: Jul. 2, 2020

(30) Foreign Application Priority Data
Jan. 11, 2018 (JP) 2018-002480

(51) Int. Cl. H04S 7/00

(52) U.S. Cl. CPC H04S 7/303

(57) ABSTRACT

A sound image localization processing section 41 performs sound signal processing for localizing a sound image of reproduction sound on a sound signal supplied from a sound source section 20. A control section 46 controls the sound signal processing performed by the sound image localization processing section, on the basis of posture tilt information that is generated by a posture tilt information generation section 30 and that indicates tilt of listening posture of a listener, and adjusts a localization position of the sound image in accordance with the tilt of the listening posture. For example, the localization position of the sound image is adjusted in an upward direction in accordance with tilt of the listening posture of the listener in a front direction, and the localization position of the sound image is adjusted in a downward direction in accordance with tilt of the listening posture in a rear direction. This makes it possible to adjust height of the localization position of the sound image to a fixed height regardless of the tilt of the listening posture in a front-rear direction. Therefore, it is possible to prevent awkward movement of a position of the sound image due to change in the tilt of the listening posture.

### TECHNICAL FIELD

The present technology relates to an acoustic processing apparatus, an acoustic processing method, and a program. The present technology makes it possible to prevent awkward movement of a position of a sound image due to change in tilt of listening posture.

### BACKGROUND ART

Conventionally, sound whose sound image is to be successfully localized has been provided regardless of its usage locations. For example, according to Patent Literature 1, correction processing is performed in view of a position of a head of a listener and a position of a speaker device installed in a headrest, for example, after a process of localizing a sound image of reproduction sound at a predetermined position is performed on a sound signal.

### CITATION LIST

### Patent Literature

Patent Literature 1: Japanese Patent Application Laid-open No. 2003-111200

### DISCLOSURE OF INVENTION

### Technical Problem

Meanwhile, for example, in the case where the listener is sitting on a reclining seat and a sound source (such as the speaker device) is disposed in front of the reclining seat, a position of a sound image is a fixed position regardless of tilt of the reclining seat. However, in the case where the speaker device installed in a headrest of the reclining seat outputs reproduction sound described in Patent Literature 1, the position of the sound image of the reproduction sound awkwardly moves in an up-down direction in accordance with a tilt angle of the reclining seat. For example, when the tilt angle of the reclining seat increases, the position of the sound image of the reproduction sound moves toward a zenith direction.

Accordingly, an objective of the present technology is to provide an acoustic processing apparatus, and acoustic processing method, and a program that make it possible to prevent awkward movement of the position of the sound image due to change in tilt of listening posture in a front-rear direction.

### Solution to Problem

According to a first aspect of the present technology, an acoustic processing apparatus includes:
a sound image localization processing section that performs sound signal processing for localizing a sound image of reproduction sound; and
a control section that controls the sound signal processing performed by the sound image localization processing section, on the basis of tilt of listening posture of a listener of the reproduction sound, and adjusts a localization position of the sound image in accordance with the tilt of the listening posture.

According to the present technology, the sound image localization processing section performs sound signal processing for localizing the sound image of the reproduction sound through filtering processing using a transfer function of sound from a virtual speaker to the listener of the reproduction sound with regard to localization of the sound image. The control section controls the sound signal processing performed by the sound image localization processing section, on the basis of the tilt of the listening posture of the listener in a front-rear direction, and adjusts the localization position of the sound image in accordance with the tilt of the listening posture. For example, the control section performs control in such a manner that the localization position of the sound image is adjusted in an up-down direction in accordance with the tilt of the listening posture, adjusts the localization position of the sound image in an upward direction in accordance with tilt of the listening posture in a front direction set by the listener, adjusts the localization position of the sound image in a downward direction in accordance with tilt in a rear direction, and adjusts height of the localization position of the sound image to a fixed height regardless of the tilt of the listening posture in the front-rear direction. In addition, the control section may adjust the localization position of the sound image in the up-down direction in accordance with tilt of the listening posture set by external equipment.

The sound image localization processing section supplies, to a speaker device, a sound signal subjected to the sound signal processing, the speaker device being disposed at a predetermined position near a head of the listener such as a headrest position on a seat back of a chair on which the listener sits. In addition, the acoustic processing apparatus further includes a tilt detection section that detects tilt of the seat back, and the control section uses, as the tilt of the listening posture, the tilt of the seat back detected by the tilt detection section. In addition, the acoustic processing apparatus further includes a correction processing section that performs correction processing of the sound signal processed by the sound image localization processing section, on the basis of correction control information corresponding to a position of the head of the listener relative to the speaker device. The sound signal subjected to the correction processing performed by the correction processing section may be supplied to the speaker device.

According to a second aspect of the present technology, an acoustic processing method includes:
performing, by the sound image localization processing section, the sound signal processing for localizing a sound image of reproduction sound at a predetermined position; and
controlling, by the control section, the sound signal processing performed by the sound image localization processing section, on the basis of tilt of listening posture of a listener of the reproduction sound, and adjusting, by the control section, a position of the sound image in accordance with the tilt of the listening posture.

According to a third aspect of the present technology, a program that causes a computer to execute sound signal processing includes:
performing the sound signal processing for localizing a sound image of reproduction sound at a predetermined position; and
controlling the sound signal processing on the basis of tilt of listening posture of a listener of the reproduction sound, and adjusting a position of the sound image in accordance with the tilt of the listening posture.

Note that the program of the present technology is a program that can be provided using a storage medium and a communication medium that are provided to a general-purpose computer that can execute various program codes in a computer-readable form, for example, a storage medium such as an optical disc, a magnetic disk, semiconductor memory or a communication medium such as a network. By providing such a program in the computer-readable form, processing corresponding to the program is executed on a computer.

### Advantageous Effects of Invention

According to the present technology, the sound signal processing for localizing a sound image of reproduction sound is performed, the sound signal processing is controlled on the basis of tilt of listening posture of a listener of the reproduction sound, and a localization position of the sound image is adjusted in accordance with the tilt of the listening posture. This makes it possible to prevent awkward movement of the position of the sound image in the up-down direction due to tilt of posture of the listener in the front-rear direction. Note that, the effect described in the present specification is just an example and is not a limitation. There may be additional effects.

### BRIEF DESCRIPTION OF DRAWINGS

FIG. 1 is a diagram illustrating an example of a configuration of an acoustic system.

FIG. 2 is a diagram illustrating an example of arrangement of speaker devices.

FIG. 3 is a diagram illustrating an example of a configuration of a first embodiment of an acoustic processing section.

FIG. 4 is a diagram for describing a principle of sound image localization processing.

FIG. 5 is a diagram illustrating an example of a case of switching between a plurality of heights of real channel speakers.

FIG. 6 is a flowchart illustrating operation of the acoustic processing section.

FIG. 7 is a diagram illustrating examples of a position of a sound image of reproduction sound and tilt of posture of a listener in a front-rear direction.

FIG. 8 is a diagram illustrating an example of a configuration of a second embodiment of an acoustic processing section.

FIG. 9 is a diagram for describing a principle of sound image localization processing.

### MODE(S) FOR CARRYING OUT THE INVENTION

Embodiments for implementing the present technology will be described below. Note that, the description will be given in the following order.

### 1. Configuration of Acoustic System

### 2. First Embodiment

### 3. Second Embodiment

### 4. Other Embodiments

### 1. Configuration of Acoustic System

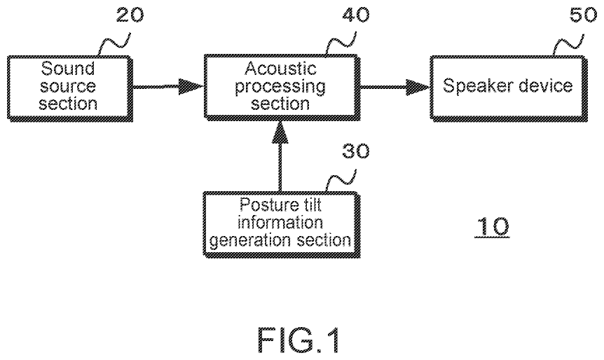

Hereinafter, with reference to the drawings, a configuration of an acoustic system that uses an acoustic processing apparatus according to the present technology will be described. FIG. 1 illustrates an example of the configuration of the acoustic system. An acoustic system 10 includes a sound source section 20, a posture tilt information generation section 30, an acoustic processing section 40, and a speaker device 50. The acoustic processing section 40 corresponds to the acoustic processing apparatus according to the present technology.

The sound source section 20 has at least any of a recording medium reproduction function or a signal reception function. The recording medium reproduction function is a function of outputting a sound signal to an outside. The sound signal is obtained by reproducing content stored in a recording medium fixed to the sound source section 20 (such as a hard disk apparatus or a memory apparatus, for example) or a recording medium detachably attached to the sound source section 20 (such as a disc-like recording medium or a memory apparatus, for example). The signal reception function is a function of outputting, to the outside, a sound signal of content obtained by receiving an airwave or a sound signal of content received via a network. The sound source section 20 outputs the sound signal to the acoustic processing section 40, the sound signal being output by using the recording medium reproduction function or the signal reception function.

The posture tilt information generation section 30 generates posture tilt information indicating tilt of listening posture of a listener, and outputs the generated posture tilt information to the acoustic processing section 40. The posture tilt information generation section 30 includes a tilt detection section configured in such a manner that a position detection sensor, a tilt sensor, or the like is installed in a reclining seat on which the listener sits, for example. The position detection sensor indicates a tilt position of a seat back. The tilt sensor detects a tilt angle of the seat back. The posture tilt information generation section 30 generates posture tilt information indicating tilt of posture in a front-rear direction, while using, as the tilt of the posture of the listener in the front-rear direction, the tilt of the seat back detected by the tilt detection section. In addition, in the case where external equipment controls tilt of the seat back of the reclining seat, the posture tilt information generation section 30 may use, as the posture tilt information, control information for controlling the tilt of the seat back. In addition, in the case of a seat whose seat back is integrated with a sitting surface at a predetermined angle, the posture tilt information generation section 30 may use, as the posture tilt information and in a similar way, a result of detecting the tilt of the seat back or control information for tilting the whole reclining seat to tilt the seat back. In addition, it is also possible for the posture tilt information generation section 30 to recognize a subject by using an image that captures the listener, detect tilt of posture of a head of the listener in the front-rear direction on the basis of a result of the recognition, and generate posture tilt information. In addition, as information indicating tilt of listening posture of the listener, it is also possible to use a detection result obtained by installing a pressure sensor in the seat back of the reclining seat. In this case, it is possible to detect or estimate a tilt angle or a tilt position of the reclining seat, or seating posture of the listener in accordance with an output result of the pressure sensor.

On the basis of the posture tilt information generated by the posture tilt information generation section 30, the acoustic processing section 40 performs a process of adjusting a localization position of the sound image of the reproduction sound, on the sound signal supplied from the sound source section 20, and outputs the sound signal subjected to the process to the speaker device 50. Note that, details of the acoustic processing section 40 will be described later.

The speaker device 50 is disposed at a predetermined position near the head of the listener. For example, the speaker device 50 includes a left channel speaker SPL and a right channel speaker SPR, although they are not illustrated. Each of the left channel speaker SPL and the right channel speaker SPR may include a single speaker, which may be a so-called hi-fi speaker that includes a super tweeter or a woofer and that makes it possible to output high-quality sound.

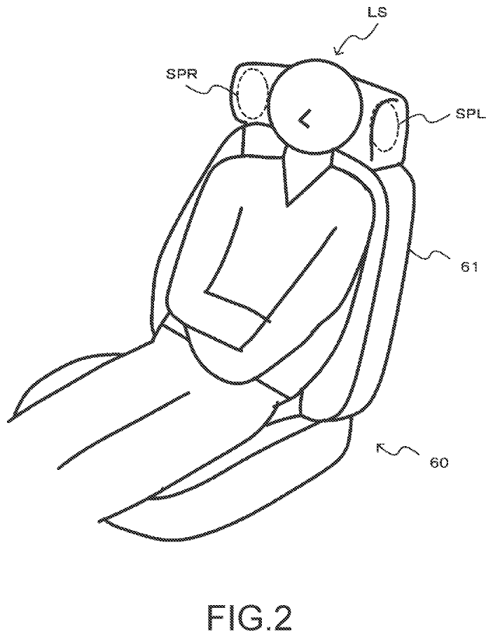

FIG. 2 illustrates an example of arrangement of the speaker device. The speaker device 50 is disposed at a headrest position on a seat back 61 of a seat 60. The headrest position is a position near a head of a listener LS. In addition, the left channel speaker SPL of the speaker device 50 is disposed on a left side of the head. The right channel speaker SPR of the speaker device 50 is disposed on a right side of the head. The left channel speaker SPL outputs a reproduction sound based on a left channel sound signal supplied from the acoustic processing section 40. In addition, the right channel speaker SPR outputs a reproduction sound based on a right channel sound signal supplied from the acoustic processing section 40.

### 2. First Embodiment

Next, a first embodiment of the acoustic processing section will be described. Note that, according to the first embodiment, a case where the reclining seat is a car seat, a head of an occupant is supported by a headrest, and the headrest includes the speaker device, will be described. In this case, a listener (the occupant of the car) sitting on the reclining seat hears reproduction sounds that are output from the left channel speaker SPL and the right channel speaker SPR positioned diagonally behind the head of the listener.

The acoustic processing section according to the first embodiment shifts positions of sound images of sounds reproduced by the speakers installed in the headrest to positions of sound images of sounds reproduced by virtual speakers, and thereby removes a feeling of strangeness and a feeling of discomfort generated when the reproduction sounds are heard from the positions near the back of the head of the listener or the positions behind ears of the listener. In addition, localization positions of the sound images of the reproduction sounds are adjusted to desired positions on the basis of tilt of posture of the listener in the front-rear direction. In addition, it is assumed that the sound signal output from the sound source section 20 to the acoustic processing section 40 is a two-channel signal.

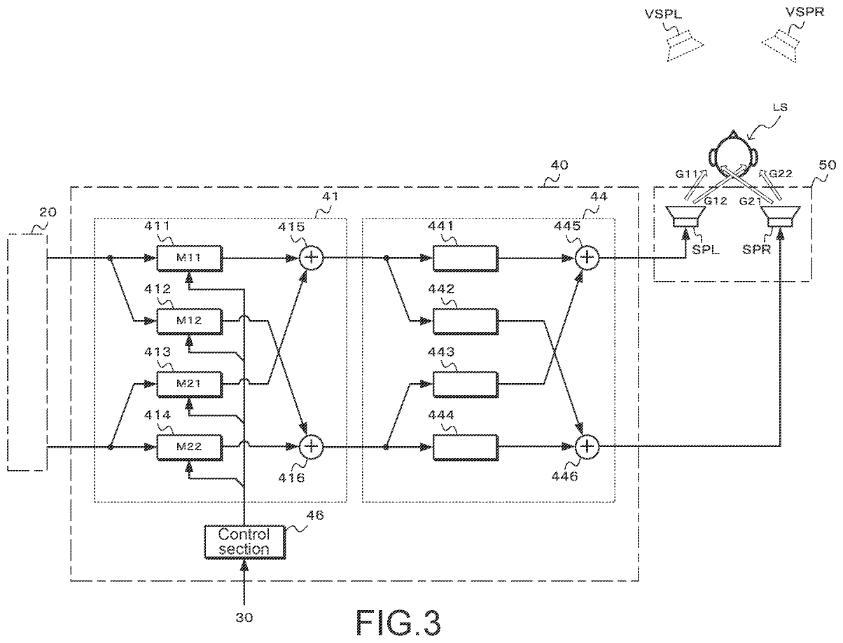

FIG. 3 illustrates an example of a configuration of the first embodiment of the acoustic processing section. The acoustic processing section 40 includes a sound image localization processing section 41, a correction processing section 44, and a control section 46.

The sound image localization processing section 41 performs sound signal processing for localizing a sound image of reproduction sound. Specifically, the sound image localization processing section 41 performs a process of localizing sound images of the reproduction sounds that are output from the left channel speaker SPL and the right channel speaker SPR, at positions of sound images of sounds reproduced by a virtual left channel speaker VSPL and a virtual right channel speaker VSPR.

The correction processing section 44 performs correction processing on the sound signals output from the sound image localization processing section 41 as if the sound signals were accurately output from the virtual left channel speaker VSPL and the virtual right channel speaker VSPR. This makes it possible to remove a feeling of strangeness and a feeling of discomfort generated when the reproduction sounds are heard from the positions near the back of the head of the listener or the positions behind ears of the listener, and this allows the listener to hear the sounds as natural sounds.

The control section 46 controls the sound signal processing performed by the sound image localization processing section 41, on the basis of the tilt of the listening posture of the listener of the reproduction sounds, and adjusts the localization positions of the sound images in accordance with the tilt of the listening posture. For example, the control section 46 adjusts the localization positions of the sound images of the reproduction sounds in an up-down direction in accordance with the tilt of the listening posture, and controls the localization positions in such a manner that the positions of the sound images of the reproduction sounds do not move awkwardly in the up-down direction even when the tilt angle of the seat back of the reclining seat changes.

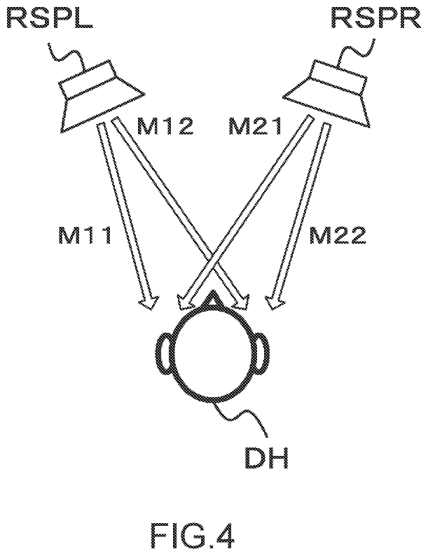

Next, the details of the respective sections of the acoustic processing apparatus according to the first embodiment will be described. First, a principle of the sound image localization processing will be described before describing the sound image localization processing section 41. FIG. 4 is a diagram for describing the principle of the sound image localization processing.

As illustrated in FIG. 4, a position of a dummy head DH is assumed to be the position of the listener in a predetermined reproduction sound filed. An actual left channel speaker (hereinafter, referred to as a “real left channel speaker”) RSPL and an actual right channel speaker (hereinafter, referred to as a “real right channel speaker”) RSLR are disposed at left and right virtual speaker positions at which the sound images are to be localized (the positions assumed to be the positions of the speakers) relative to the listener who is in the position of the dummy head DH.

Next, both ear parts of the dummy head DH collect sounds output from the real left channel speaker RSPL and the real right channel speaker RSPR, and transfer functions (HRTF) are measured in advance. The transfer functions (HRTF) represent how the sounds output from the real left channel speaker RSPL and the real right channel speaker RSPR change when the sounds arrive at the both ear parts of the dummy head DH.

As illustrated in FIG. 4, according to the first embodiment, M11 is a transfer function of a sound from the real left channel speaker RSPL to the left ear of the dummy head DH, and M12 is a transfer function of a sound from the real left channel speaker RSPL to the right ear of the dummy head DH. In a similar way, M21 is a transfer function of a sound from the real right channel speaker RSPR to the left ear of the dummy head DH, and M22 is a transfer function of a sound from the real right channel speaker RSPR to the right ear of the dummy head DH.

In this case, the sound signals of the sounds output from the left channel speaker SPL and the right channel speaker SPR of the headrest, which are to be located near the ears of the listener, are processed by using the previously measured transfer functions described above with reference to FIG. 4. Subsequently, the left channel speaker SPL and the right channel speaker SPR output reproduction sounds of the processed sound signals.

This makes it possible to localize the sound images of the reproduction sounds that are output from the left channel speaker SPL and the right channel speaker SPR in such a manner that the listener feels as if the reproduction sounds output from the left channel speaker SPL and the right channel speaker SPR were output from the positions of the virtual left channel speaker VSPL located at the position of the real left channel speaker RSPL and the virtual right channel speaker VSPR located at the position of the real right channel speaker RSPR.

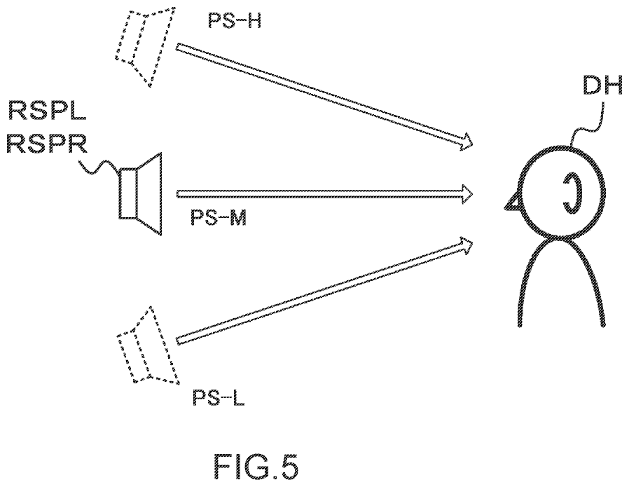

In addition, the transfer functions M11, M12, M21, and M22 are generated with regard to respective heights by changing the heights of the real channel speakers. FIG. 5 illustrates an example of a case of switching between a plurality of heights of the real channel speakers. The transfer functions M11, M12, M21, and M22 are measured in advance with regard to respective heights while changing the heights of the real left channel speaker RSPL and the real right channel speaker RSPR to heights of positions PS-L, PS-M, and PS-H.

Note that, here, the dummy head DH has been used for measuring the transfer functions (HRTF). However, the present technology is not limited thereto. It is also possible to measure the transfer functions of the sounds while a person actually sits down in the reproduction sound field for measuring the transfer functions and microphones are disposed near his/her ears.

The sound image localization processing section 41 illustrated in FIG. 3 performs filtering processing by using the previously measured transfer functions. The sound image localization processing section 41 includes four filters 411, 412, 413, and 414, and two adders 415 and 416.

The filter 411 is a filter that processes the left channel sound signal supplied from the sound source section 20 by using the transfer function M11, and supplies the processed sound signal to the adder 415 for the left channel. In addition, the filter 412 is a filter that processes the left channel sound signal supplied from the sound source section 20 by using the transfer function M12, and supplies the processed sound signal to the adder 416 for the right channel.

In addition, the filter 413 is a filter that processes the right channel sound signal supplied from the sound source section 20 by using the transfer function M21, and supplies the processed sound signal to the adder 415 for the left channel. In addition, the filter 414 is a filter that processes the right channel sound signal supplied from the sound source section 20 by using the transfer function M22, and supplies the processed sound signal to the adder 416 for the right channel.

The adder 415 adds the sound signals supplied from the filer 411 and the filer 413. The adder 416 adds the sound signals supplied from the filer 412 and the filer 414.

This makes it possible to localize sound images in such a manner that the virtual left channel speaker VSPL outputs a sound of the sound signal output from the adder 415 for the left channel, and the virtual right channel speaker VSPR outputs a sound of the sound signal output from the adder 416 for the right channel.

The correction processing section 44 performs the correction processing on the sound signals output from the sound image localization processing section 41 and localizes the sounds output from the left channel speaker SPL and the right channel speaker SPR as if the sounds were accurately output from the virtual left channel speaker VSPL and the virtual right channel speaker VSPR.

The correction processing section 44 is a sound filter to which a transaural system is applied. The transaural system is a technology of achieving effects similar to a binaural system even in the case of using the speakers. The binaural system is a method of precisely reproducing sounds by using headphones.

With reference to the example illustrated in FIG. 3, the transaural system will be described. The transaural system removes effects of transfer functions G11, G12, G21, and G22 of the sounds output from the left channel speaker SPL and the right channel speaker SPR to the respective left and right ears of the listener, from the sounds output from the respective speakers.

In other words, the correction processing section 44 removes effects of the transfer functions from the sounds to be output from the left channel speaker SPL and the right channel speaker SPR in the reproduction sound field. This makes it possible to accurately localize the sound images of the sounds output from the left channel speaker SPL and the right channel speaker SPR at the positions corresponding to the virtual speaker positions. To remove the effects of the transfer functions of the sounds from the left channel speaker SPL and the right channel speaker SPR to the left and right ears of the listener, the correction processing section 44 includes filers 441, 442, 443, and 444 and adders 445 and 446 for processing sound signals in accordance with inverse functions of the transfer functions of a sound from the right channel speaker SPR to the left and right ears of the listener, for example.

Note that, the transfer functions of the sounds from the left channel speaker SPL and the right channel speaker SPR of the headrest to the left and right ears of the listener change when the shape or material of the headrest, the installation position of the speaker device, performance or characteristics of the speakers, or the like is changed. In other words, it can be said that different transfer functions are prepared for different shapes of headrests including the speaker device. Therefore, coefficient data for removing the effects of the transfer functions that will occur in the case of hearing the sounds by using the headrest is previously set in accordance with the transfer functions measured by using the headrest to be used, and the coefficient data is stored. Note that, the coefficient data may be stored in a storage medium or may be stored in the correction processing section 44 or the control section 46.

As described above, each of the respective filters 441, 442, 443, and 444 of the correction processing section 44 performs the correction processing by using the coefficient data that is previously set in accordance with the shape or material of the headrest, the installation position of the speaker device, performance or characteristics of the speaker, or the like.

The sound signal output from the adder 415 for the left channel of the sound image localization processing section 41 is supplied to the filter 441 for the left channel and the filter 442 for the right channel of the correction processing section 44. The sound signal output from the adder 416 for the right channel of the sound image localization processing section 41 is supplied to the filter 443 for the left channel and the filter 444 for the right channel of the correction processing section 44.

Each of the respective filters 441, 442, 443, and 444 performs, on a sound signal supplied to each filter, the filter processing for removing effects of a transfer function of a sound to an ear of the listener. The transfer function is measured by using the headrest including the left channel speaker SPL and the right channel speaker SPR.

Note that, each of the filters of the correction processing section 44 removes effects of the transfer function G11, G12, G21, or G22 in the reproduction sound filed by processing a sound signal using an inverse function of the transfer function G11, G12, G21, or G22 illustrated in FIG. 3.

Output of the filer 441 is supplied to the adder 445 for the left channel. Output of the filer 442 is supplied to the adder 446 for the right channel. In a similar way, output of the filer 443 is supplied to the adder 445 for the left channel. Output of the filer 444 is supplied to the adder 446 for the right channel.

The adders 445 and 446 add the supplied sound signals. The adder 445 outputs the added sound signals to the left channel speaker SPL. The adder 446 outputs the added sound signals to the right channel speaker SPR. This makes it possible to remove the effects of the transfer functions corresponding to the current position of the head of the listener in the reproduction sound filed, from sounds output from the left channel speaker SPL and the right channel speaker SPR of the headrest. In addition, this makes it possible to localize sound images of the sounds as if the sounds were accurately output from the virtual left channel speaker VSPL and the virtual right channel speaker VSPR.

The control section 46 controls the sound image localization processing section 41 on the basis of posture tilt information of the listener. Specifically, for example, in the case where a tilt angle of the seat back of the reclining seat increases, the control section 46 switches between the transfer functions M11, M12, M13, and M14 of the filters 411, 412, 413, and 414 of the sound image localization processing section 41 on the basis of the posture tilt information, and prevents the positions of the sound images of the reproduction sounds from moving in the upward direction.

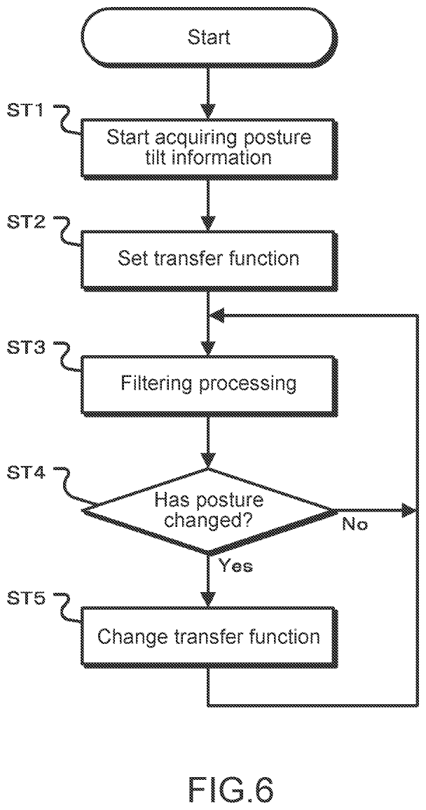

FIG. 6 is a flowchart illustrating operation of the acoustic processing section. In Step ST1, the acoustic processing section 40 starts acquiring the posture tilt information. The acoustic processing section 40 starts acquiring the posture tilt information from the posture tilt information generation section 30, and proceeds to Step ST2. Note that, in the case where it is impossible to acquire the posture tilt information from the posture tilt information generation section 30, the acoustic processing section 40 sets posture of the listener to preset posture.

In Step ST2, the acoustic processing section 40 sets the transfer functions. The acoustic processing section 40 sets transfer functions corresponding to the tilt of the posture of the listener in the front-rear direction for the filers 411 to 414 on the basis of the posture tilt information acquired in Step ST1, and proceeds to Step ST3.

In Step ST3, the acoustic processing section 40 performs the filtering processing. The acoustic processing section 40 performs the filtering processing on sound signals output from the sound source section 20 by using the set transfer functions, and proceeds to step ST4.

In Step ST4, the acoustic processing section 40 determines whether the posture has changed. The acoustic processing section 40 determines whether the tilt of the posture of the listener in the front-rear direction has changed on the basis of the posture tilt information output from the posture tilt information generation section 30. In the case where it is determined that the posture has not changed, the acoustic processing section 40 returns to Step ST3 and continues performing the filtering processing. Alternatively, in the case where the change in the posture is detected, the acoustic processing section 40 proceeds to Step ST5.

In Step ST5, the acoustic processing section 40 changes the transfer functions. The acoustic processing section 40 changes the transfer functions in accordance with the tilt of the posture of the listener in the front-rear direction indicated by the posture tilt information acquired from the posture tilt information generation section 30, returns to Step ST3, and performs the filtering processing by using the changed transfer functions.

Note that, in the case where the transfer functions are previously measured with regard to respective heights of the plurality of levels of the real left channel speaker RSPL and the real right channel speaker RSPR as illustrated in FIG. 5, the measured transfer functions are associated with angular ranges of the tilt of the posture of the listener in the front-rear direction. Here, in the case where the tilt of the changed posture exceeds the angular range of the tilt of the posture corresponding to the set transfer functions in Step ST4, the acoustic processing section 40 proceeds to Step ST5, and changes the set transfer functions to transfer functions corresponding to the tilt of the changed posture.

As described above, according to the first embodiment, in the case where the left channel speaker SPL and the right channel speaker SPR of the headrest outputs the reproduction sounds on the basis of the 2ch sound signal output from the sound source section 20, it is possible for the listener to hear the reproduction sounds as if the reproduction sounds were output from the virtual left channel speaker VSL and the virtual right channel speaker VSR. Accordingly, the listener hears the sounds as if the sounds were output from the front direction of the listener although the listener actually hears the sounds output from the left channel speaker SPL and the right channel speaker SPR located diagonally behind the head of the listener. This makes it possible to prevent the listener from feeling strangeness or discomfort as if the reproduction sounds output from the left channel speaker SPL and the right channel speaker SPR stuck to the back side of the listener, and this allows the listener to hear the sounds well.

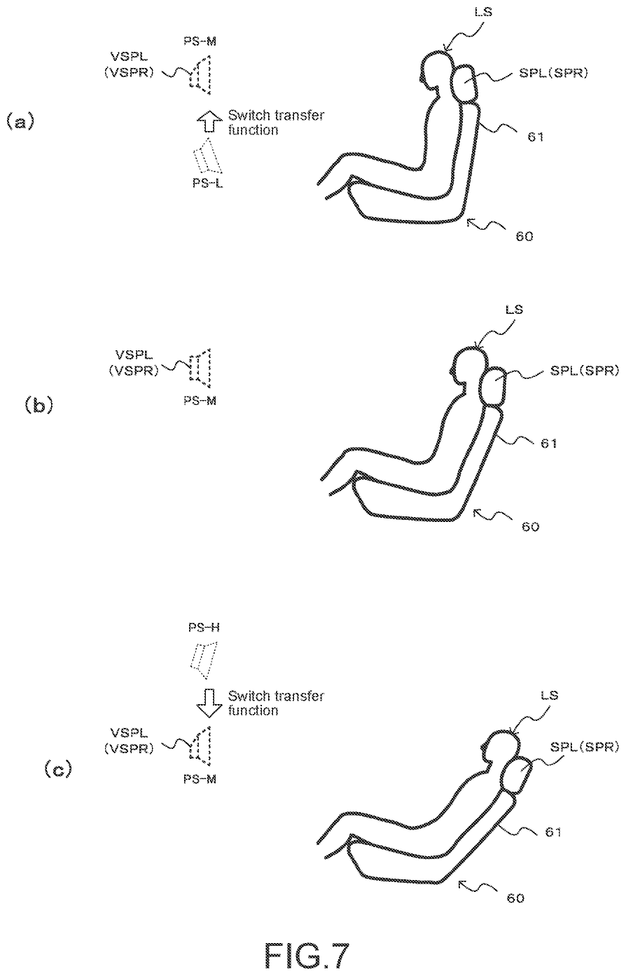

In addition, even when the angle of the seat back of the seat is changed, it is possible to prevent awkward movement of the positions of the sound images of the reproduction sounds in the up-down direction in accordance with the changed angle of the seat back (corresponding to tilt of the posture of the listener in the front-rear direction). FIG. 7 illustrates examples of the positions of the sound images of reproduction sounds and the tilt of posture of the listener in the front-rear direction. For example, when the angle of the seat back 61 of the seat 60 is an angle illustrated in FIG. 7(b), localization positions of the sound images of the reproduction sounds are the positions of the virtual left channel speaker VSPL and the virtual right channel speaker VSPR that are disposed at the position PS-M in front of the listener LS. Here, the control section 46 adjusts the localization positions of the sound images in the upward direction in accordance with the tilt of the listening posture in the front direction set by the listener, and adjusts the localization positions of the sound images in a downward direction in accordance with the tilt in the rear direction. For example, when the seat back 61 is put upright as illustrated in FIG. 7(a) and the transfer functions are fixed as described in the conventional technologies, localization positions of the sound images of the reproduction sounds are the positions of the virtual left channel speaker VSPL and the virtual right channel speaker VSPR that are disposed at the position PS-L in front of the listener LS. However, according to the present technology, the transfer functions are changed in accordance with the tilt of the posture of the listener in the front-rear direction, and this makes it possible to set the localization positions of the sound images of the reproduction sounds to the positions of the virtual left channel speaker VSPL and the virtual right channel speaker VSPR that are disposed at the position PS-M in front of the listener LS. In addition, when the seat back 61 is reclined as illustrated in FIG. 7(c) and the transfer functions are fixed as described in the conventional technologies, the localization positions of the sound images of the reproduction sounds are the positions of the virtual left channel speaker VSPL and the virtual right channel speaker VSPR that are disposed at the position PS-H in front of the listener LS. However, according to the present technology, the transfer functions are changed in accordance with the tilt of the posture of the listener in the front-rear direction, and this makes it possible to set the localization positions of the sound images of the reproduction sounds to the positions of the virtual left channel speaker VSPL and the virtual right channel speaker VSPR that are disposed at the position PS-M in front of the listener LS. Therefore, by adjusting the height of the localization positions of the sound images to a fixed height regardless of the tilt of the listening posture in the front-rear direction, it is possible to prevent awkward movement of the positions of the sound images of the reproduction sounds in the up-down direction in accordance with change in the tilt of the posture of the listening posture in the front-rear direction.

### 3. Second Embodiment

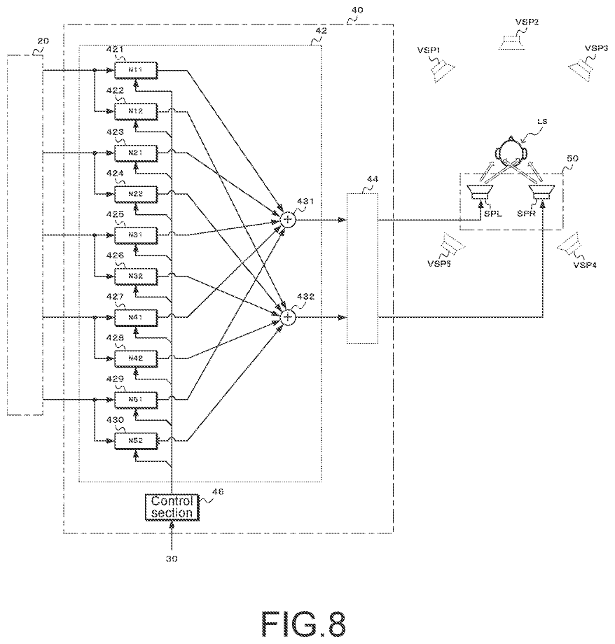

Next, a case where the sound source section 20 outputs a multi-channel sound signal of more than two channels will be described. FIG. 8 is a diagram illustrating an example of a configuration of a second embodiment of an acoustic processing section. A sound image localization processing section 42 of an acoustic processing section 40 according to the second embodiment localizes sound images of sounds output from speakers, on the basis of a principle similar to that of the sound image localization processing section 41 according to the first embodiment. However, the second embodiment is different from the first embodiment in that sound images of sounds output from a left channel speaker SPL and a right channel speaker SPR installed in a headrest are localized as if the sound images were output from five virtual speakers VSP1 to VSP5 indicated by dotted lines as illustrated in FIG. 8.

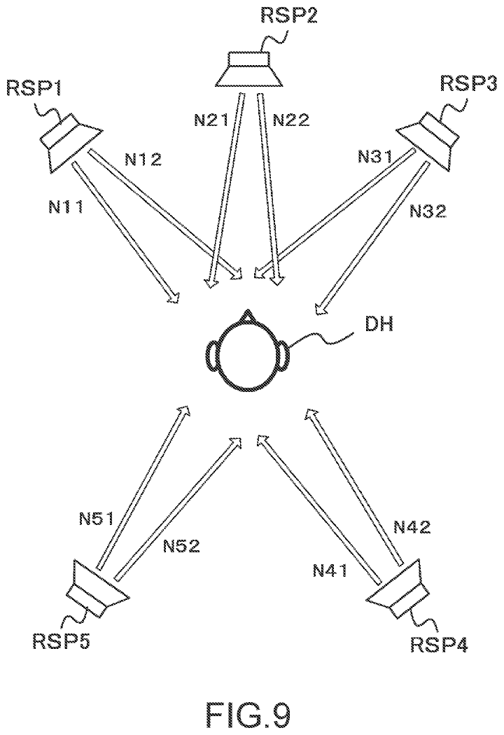

FIG. 9 is a diagram for describing the principle of the sound image localization processing performed by the acoustic processing section according to the second embodiment illustrated in FIG. 8. As illustrated in FIG. 9, a position of a dummy head DH is assumed to be a position of a listener in a predetermined reproduction sound filed. Real speakers RSP1 to RSP5 are actually disposed at positions of the virtual speakers (positions assumed to be the positions of the speakers) for localizing the sound images relative to the listener who is at the position of the dummy head DH. In addition, transfer functions (HRTF) of sounds output from the respective real speakers RSP1 to RSP5 to each of left and right ears of the dummy head DH are measured in advance.

As illustrated in FIG. 9, according to the second embodiment, N11 is a transfer function of a sound from the real speaker RSP1 to the left ear of the dummy head DH, and N12 is a transfer function of a sound from the real speaker RSP1 to the right ear of the dummy head DH. In addition, N21 is a transfer function of a sound from the real speaker RSP2 to the left ear of the dummy head DH, and N22 is a transfer function of a sound from the real speaker RSP2 to the right ear of the dummy head DH.

In a similar way, N31 is a transfer function of a sound from the real speaker RSP3 to the left ear of the dummy head DH, and N32 is a transfer function of a sound from the real speaker RSP3 to the right ear of the dummy head DH. N41 is a transfer function of a sound from the real speaker RSP4 to the left ear of the dummy head DH, and N42 is a transfer function of a sound from the real speaker RSP4 to the right ear of the dummy head DH. In addition, N51 is a transfer function of a sound from the real speaker RSP5 to the left ear of the dummy head DH, and N52 is a transfer function of a sound from the real speaker RSP5 to the right ear of the dummy head DH.

In addition, the transfer functions N11, N12, N21, N22, N31, N32, N41, N42, N51, and N52 are previously measured with regard to a plurality of different positions while moving the positions of the virtual speakers VSP-1 to VSP-5 in the up-down direction in a way similar to the first embodiment.

The acoustic processing section 40 processes, for example, a 5-channel sound signal output from the sound source section 20 by using the corresponding transfer functions that have been previously measured, performs the correction processing for removing effects of the transfer functions in a reproduction sound filed, outputs processed sound signals to a speaker device 50, and outputs reproduction sounds from the left channel speaker SPL and the right channel speaker SPR of the speaker device 50 installed in the headrest.

The sound image localization processing section 42 illustrated in FIG. 8 performs filtering processing by using the previously measured transfer functions. The sound image localization processing section 42 includes 10 filters 421 to 430, and two adders 431 and 432.

The filter 421 is a filter that processes a first channel sound signal supplied from the sound source section 20 by using the transfer function N11, and supplies the processed sound signal to the adder 431 for the left channel. In addition, the filter 422 is a filter that processes the first channel sound signal supplied from the sound source section 20 by using the transfer function N12, and supplies the processed sound signal to the adder 432 for the right channel.

The filter 423 is a filter that processes a second channel sound signal supplied from the sound source section 20 by using the transfer function N11, and supplies the processed sound signal to the adder 431 for the left channel. In addition, the filter 424 is a filter that processes the second channel sound signal supplied from the sound source section 20 by using the transfer function N12, and supplies the processed sound signal to the adder 432 for the right channel.

The filter 425 is a filter that processes a third channel sound signal supplied from the sound source section 20 by using the transfer function N11, and supplies the processed sound signal to the adder 431 for the left channel. In addition, the filter 426 is a filter that processes the third channel sound signal supplied from the sound source section 20 by using the transfer function N12, and supplies the processed sound signal to the adder 432 for the right channel.

The filter 427 is a filter that processes a fourth channel sound signal supplied from the sound source section 20 by using the transfer function N11, and supplies the processed sound signal to the adder 431 for the left channel. In addition, the filter 422 is a filter that processes the fourth channel sound signal supplied from the sound source section 20 by using the transfer function N12, and supplies the processed sound signal to the adder 432 for the right channel.

The filter 429 is a filter that processes a fifth channel sound signal supplied from the sound source section 20 by using the transfer function N11, and supplies the processed sound signal to the adder 431 for the left channel. In addition, the filter 430 is a filter that processes the fifth channel sound signal supplied from the sound source section 20 by using the transfer function N12, and supplies the processed sound signal to the adder 432 for the right channel.

The adder 431 adds the sound signals supplied from the filters 421, 423, 425, 427, and 429. The adder 432 adds the sound signals supplied from the filters 422, 424, 426, 428, and 430.

This makes it possible to localize sound images in such a manner that the virtual speakers VSP1 to VSP5 output a sound of the sound signal output from adder 431 for the left channel, and a sound of the sound signal output from the adder 432 for the right channel.

The correction processing section 44 according to the second embodiment is configured in a way similar to the first embodiment. The correction processing section 44 performs the correction processing on the sound signals output from the sound image localization processing section 42 and localizes the sounds output from the left channel speaker SPL and the right channel speaker SPR as if the sounds were accurately output from the virtual speakers VSP1 to VSP5.

The control section 46 controls the sound image localization processing section 42 on the basis of posture tilt information of the listener. Specifically, for example, in the case where a tilt angle of the seat back of the reclining seat increases, the transfer functions N11, N12, N21, N22, N31, N32, N41, N42, N51, and N52 of the filters 421 to 430 of the sound image localization processing section 42 are switched on the basis of the posture tilt information, and the positions of the sound images of the reproduction sounds are prevented from moving in the upward direction.

As described above, according to the second embodiment, in the case where the left channel speaker SPL and the right channel speaker SPR of the headrest output the reproduction sounds on the basis of the multi-channel sound signal output from the sound source section 20, it is possible for the listener to hear the reproduction sounds as if the reproduction sounds were output from the positions of the virtual speakers VSP1 to VSP-5.

Accordingly, in a way similar to the first embodiment, the listener hears the sounds as if the sounds were output from the front direction of the listener although the listener hears the sounds output from the left channel speaker SPL and the right channel speaker SPR located diagonally behind the head of the listener. This makes it possible to prevent the listener from feeling strangeness or discomfort as if the reproduction sounds output from the left channel speaker SPL and the right channel speaker SPR stuck to the back side of the listener, and this allows the listener to hear the sounds well. In addition, it is possible to prevent awkward movement of the positions of the sound images of the reproduction sounds in the up-down direction in accordance with change in the tilt of the posture of the listener in the front-rear direction.

### 4. Other Embodiments

In the first and second embodiments, the case where the reclining seat is the car seat, the speaker device is installed in the headrest that is provided on the top of the seat back, and the acoustic processing section 40 includes the sound image localization processing section 41 (42) and the correction processing section 44 has been described. However, it is also possible to integrate the sound image localization processing section 41 with the correction processing section 44, and to perform filtering processing in which the processes performed by the sound image localization processing section 41 and the processes performed by the correction processing section 44 are combined. In addition, it is sufficient to install the speaker device at a predetermined position near a head of a listener, and the predetermined position is not limited to the headrest.

In addition, it is sufficient for the acoustic processing section to prevent awkward movement of the positions of the sound images of the reproduction sounds in the up-down direction in accordance with change in the tilt of the posture of the listener in the front-rear direction. The acoustic processing section does not have to include the correction processing section.

In addition, the seat in which the speaker device is installed is not limited to the car seat. For example, it is also possible to install the speaker device in reclining seats provided in an airplane, a train, or the like as described above. In addition, it is also possible to install the speaker device in seats used for an amusement ride or the like that is established in an amusement park and that carries riders in such a manner that tilt of postures of the riders changes in the front-rear direction as described above. In addition, it is also possible to install the speaker device not only in a seat provided in a mobile object but also in a seat provided at a fixed position, as described above. For example, it is possible to install the speaker device in a reclining seat in a place to rest or in a massage chair with a reclining function.

In addition, it is possible to prevent awkward movement of the localization positions of the sound images of the reproduction sounds in the up-down direction by adjusting the localization positions in accordance with change in tilt of posture of a listener in the front-rear direction. In addition, it is also possible to provide dynamic realistic sensations by controlling movement directions and movement amounts of the localization positions of the sound images of the reproduction sounds in accordance with change in tilt of the posture. For example, in the case where external equipment automatically tilts a seat in the front-rear direction in conformity with reproduction of video, the control section 46 adjusts localization positions of sound images in the up-down direction in accordance with the tilt of the listening posture set by the external equipment. Here, an example of adjusting the localization positions of the sound images in the up-down direction in accordance with the tilt of the listening posture set by the external equipment will be described. In the case of automatically tilting the seat in the front-rear direction in conformity with reproduction of video by using a control signal from the external equipment, the posture tilt information generation section 30 uses the control signal from the external equipment as posture tilt information, and the control section 46 moves a localization position of a sound image more in a movement direction of the position of the sound image of the reproduction sound corresponding to the tilt of the seat, on the basis of the posture tilt information. When the localization position of the sound image of the reproduction sound is moved as described above, it is possible to dynamically reproduce quick turn behavior or the like in a scenario where the listener follows an enemy aircraft by using a simulation video of aerial warfare between aircrafts or the like, for example. In addition, for example, in the case where the seat is automatically tilted in the front direction in conformity with reproduction of simulation video of a falling scenario or the like, it is possible to dynamically reproduce falling behavior or the like by moving localization positions of sound images in a direction opposite to a movement direction of the positions of the sound images of reproduction sounds corresponding to tilt of the seat.

A series of processes described in the present specification can be executed by hardware, software, or a combined configuration of them. In the case where the series of processes is executed by software, a program in which a processing sequence is recorded can be installed into memory in a computer incorporated into dedicated hardware, whereby the program is executed, or can be installed into a general-purpose computer capable of executing various types of processes, whereby the program is executed.

For example, the program can be recorded in advance in a hard disk, a solid-state drive (SSD), or read-only memory (ROM) serving as a recording medium. Alternatively, the program can be temporarily or permanently stored (recorded) in a removable recording medium such as a flexible disk, compact disc read-only memory (CD-ROM), a magneto-optical (MO) disc, a digital versatile disc (DVD), Blu-ray Disc (BD) (registered trademark), a magnetic disk, or semiconductor memory. Such a removable recording medium can be provided as so-called packaged software.

In addition to being installed into a computer from the above-described removable recording medium, programs can be transferred from a download site to a computer via a network such as a local area network (LAN) or the Internet in a wired or wireless manner. It is possible for the computer to receive the programs which are transferred in such a manner and install the programs into a recording medium such as the hard disk contained therein.

It should be noted that the effects described in the present specification are merely the exemplification, and are by no means limited thereto, and additional effects which are not described herein may be offered. In addition, the present technology should not be interpreted to be limited to the embodiments of the technology described above. The embodiments of the technology described above disclose the present technology in the form of the exemplifications, and it is obvious that a person skilled in the art can make modifications or substitutions in the embodiments without departing from the subject matter of the present technology. That is, for deciding the subject matter of the present technology, claims should be taken into consideration.

Additionally, the acoustic processing apparatus according to the present technology may also be configured as below.

(1) An acoustic processing apparatus including:
a sound image localization processing section that performs sound signal processing for localizing a sound image of reproduction sound; and
a control section that controls the sound signal processing performed by the sound image localization processing section, on the basis of tilt of listening posture of a listener of the reproduction sound, and adjusts a localization position of the sound image in accordance with the tilt of the listening posture.
   (2) The acoustic processing apparatus according to (1),
in which the tilt of the listening posture is tilt in a front-rear direction.
   (3) The acoustic processing apparatus according to (2),
in which the control section adjusts the localization position of the sound image in an up-down direction in accordance with the tilt of the listening posture.
   (4) The acoustic processing apparatus according to (3),
in which the control section adjusts the localization position of the sound image in an upward direction in accordance with tilt of the listening posture in a front direction set by the listener, and adjusts the localization position of the sound image in a downward direction in accordance with tilt in a rear direction.
   (5) The acoustic processing apparatus according to (4),
in which the control section adjusts height of the localization position of the sound image to a fixed height regardless of the tilt of the listening posture in the front-rear direction.
   (6) The acoustic processing apparatus according to (3),
in which the control section adjusts the localization position of the sound image in the up-down direction in accordance with tilt of the listening posture set by external equipment.
   (7) The acoustic processing apparatus according to any of (1) to (6), in which
the sound image localization processing section localizes the sound image of the reproduction sound through filtering processing using a transfer function of sound from a virtual speaker to the listener, and
the control section switches the transfer function in accordance with the tilt of the listening posture and adjusts the localization position of the sound image.
   (8) The acoustic processing apparatus according to any of (1) to (7),
in which the sound image localization processing section supplies, to a speaker device, a sound signal subjected to the sound signal processing, the speaker device being disposed at a predetermined position near a head of the listener.
   (9) The acoustic processing apparatus according to (8),
in which the speaker device is disposed at a headrest position on a seat back of a chair on which the listener sits.
   (10) The acoustic processing apparatus according to (9), further including
a tilt detection section that detects tilt of the seat back,
in which the control section uses, as the tilt of the listening posture, the tilt of the seat back detected by the tilt detection section.
   (11) The acoustic processing apparatus according to any of (8) to (10), further including
a correction processing section that performs correction processing of the sound signal processed by the sound image localization processing section, on the basis of correction control information corresponding to a position of the head of the listener relative to the speaker device,
in which the sound signal subjected to the correction processing performed by the correction processing section is supplied to the speaker device.

### INDUSTRIAL APPLICABILITY

By using the acoustic processing apparatus, the acoustic processing method, and the program according to the present technology, the sound signal processing for localizing a sound image of reproduction sound is performed, the sound signal processing is controlled on the basis of tilt of listening posture of a listener of the reproduction sound, and a localization position of the sound image is adjusted in accordance with the tilt of the listening posture. This makes it possible to prevent awkward movement of the position of the sound image in the up-down direction due to tilt of posture of a listener in the front-rear direction. The present technology is suitable for equipment that localizes sound images by using reproduction sound from a seat installed in a mobile object, a stationary facility, or the like.

### REFERENCE SIGNS LIST

10 acoustic system
20 sound source section
30 posture tilt information generation section
40 acoustic processing section
41, 42 sound image localization processing section
44 correction processing section
46 control section
50 speaker device
60 seat
61 seat back
411 to 414, 421 to 430, 441 to 444 filer
415, 416, 431, 432, 445, 446 adder

1. An acoustic processing apparatus comprising:
a sound image localization processing section that performs sound signal processing for localizing a sound image of reproduction sound; and
a control section that controls the sound signal processing performed by the sound image localization processing section, on a basis of tilt of listening posture of a listener of the reproduction sound, and adjusts a localization position of the sound image in accordance with the tilt of the listening posture.

2. The acoustic processing apparatus according to claim 1,
wherein the tilt of the listening posture is tilt in a front-rear direction.

3. The acoustic processing apparatus according to claim 2,
wherein the control section adjusts the localization position of the sound image in an up-down direction in accordance with the tilt of the listening posture.

4. The acoustic processing apparatus according to claim 3,
wherein the control section adjusts the localization position of the sound image in an upward direction in accordance with tilt of the listening posture in a front direction set by the listener, and adjusts the localization position of the sound image in a downward direction in accordance with tilt in a rear direction.

5. The acoustic processing apparatus according to claim 4,
wherein the control section adjusts height of the localization position of the sound image to a fixed height regardless of the tilt of the listening posture in the front-rear direction.

6. The acoustic processing apparatus according to claim 3,
wherein the control section adjusts the localization position of the sound image in the up-down direction in accordance with tilt of the listening posture set by external equipment.

7. The acoustic processing apparatus according to claim 1, wherein
the sound image localization processing section localizes the sound image of the reproduction sound through filtering processing using a transfer function of sound from a virtual speaker to the listener, and
the control section switches the transfer function in accordance with the tilt of the listening posture and adjusts the localization position of the sound image.

8. The acoustic processing apparatus according to claim 1,
wherein the sound image localization processing section supplies, to a speaker device, a sound signal subjected to the sound signal processing, the speaker device being disposed at a predetermined position near a head of the listener.

9. The acoustic processing apparatus according to claim 8,
wherein the speaker device is disposed at a headrest position on a seat back of a chair on which the listener sits.

10. The acoustic processing apparatus according to claim 9, further comprising
a tilt detection section that detects tilt of the seat back,
wherein the control section uses, as the tilt of the listening posture, the tilt of the seat back detected by the tilt detection section.

11. The acoustic processing apparatus according to claim 8, further comprising
a correction processing section that performs correction processing of the sound signal processed by the sound image localization processing section, on a basis of correction control information corresponding to a position of the head of the listener relative to the speaker device,
wherein the sound signal subjected to the correction processing performed by the correction processing section is supplied to the speaker device.

12. An acoustic processing method comprising:
performing, by a sound image localization processing section, sound signal processing for localizing a sound image of reproduction sound; and
controlling, by a control section, the sound signal processing performed by the sound image localization processing section, on a basis of tilt of listening posture of a listener of the reproduction sound, and adjusting, by the control section, a localization position of the sound image in accordance with the tilt of the listening posture.

13. A program that causes a computer to execute sound signal processing including:
performing sound signal processing for localizing a sound image of reproduction sound; and
controlling the sound signal processing on a basis of tilt of listening posture of a listener of the reproduction sound, and adjusting a localization position of the sound image in accordance with the tilt of the listening posture.
